(19) United States
(12) Patent Application Publication
(10) Pub. No.: US 2014/0365780 A1
(43) Pub. Date: Dec. 11, 2014

(54) SYSTEM AND METHODS FOR ONE-TIME PASSWORD GENERATION ON A MOBILE COMPUTING DEVICE

(71) Applicant: Safa Movassaghi, Mission Viejo, CA (US)

(72) Inventor: Safa Movassaghi, Mission Viejo, CA (US)

(21) Appl. No.: 14/295,187

(22) Filed: Jun. 3, 2014

Related U.S. Application Data
(60) Provisional application No. 61/832,534, filed on Jun. 7, 2013.

(51) Int. Cl. H04L 29/06

(52) U.S. Cl. CPC H04L 63/0838
USPC 713/184; 726/6

(57) ABSTRACT

A method for a mobile computing device comprises downloading a one-time password initializer from an authentication server, the one-time password initializer configured to generate a device-specific signature for the mobile computing device; uploading a device-specific signature to the authentication server; and downloading a device-specific configuration and one-time password generator from the authentication server. In this way, both the mobile computing device and authentication server may independently generate equivalent one-time passwords based on unique information associated with the mobile computing device.

### CROSS REFERENCE TO RELATED APPLICATION

The present application claims the benefit of and priority to U.S. Provisional Patent Application No. 61/832,534, filed Jun. 7, 2013 and titled SYSTEM AND METHODS FOR ONE-TIME PASSWORD GENERATION ON A MOBILE COMPUTING DEVICE, the content of which is incorporated herein by reference for all purposes.

### BACKGROUND AND SUMMARY

The secure authentication of users and devices is a necessity for electronic service providers. Commonly, authentication has been accomplished through the user of static passwords. However, there are numerous drawbacks to the use of static passwords as the only requirement for authentication. Passwords may be written down, stolen, stored in memory on devices, or guessed by an un-authorized user. Further, individual users may use identical or similar user identifications and passwords for multiple electronic service providers.

For these reasons, among others, electronic service providers seeking strong user authentication may increase the number of authentication factors required to validate a user attempting to engage the electronic service provider. Authentication strength can be increased by using factors of differing nature, such as a knowledge factor in combination with a possession factor. For example, a static password may be used in combination with an electronic one-time password generator, requiring a user to have knowledge of the password as well as possession of the one-time password generator in order to be authenticated by the electronic service provider. This approach also allows for a one-time password to be generated out-of-band from the communication channel used to submit the password. This decreases the likelihood of an outside observer gaining knowledge of both the user information and the one-time password generation algorithm.

It is possible to configure an electronic device, such as a mobile phone, as an electronic one-time password generator or one-time password retriever. However, if the electronic device is lost or stolen, an unauthorized user may gain access to the one-time password generator. In another scenario, a hacker may gain remote access to the contents of the electronic device and be able to copy or recreate the one-time password generator software. This could increase the possibility of unauthorized access to electronic service providers.

Additionally, the most common algorithms for one-time password generation are time based. In other words, a single one-time password may be generated over a range of time, for example over one minute. This approach to one-time password generation has a disadvantage in that if the password were to be intercepted, a period of time would exist where the password could be implemented by the interceptor to gain access to an electronic service provider. However, while generating a new password each and every time a one-time password is needed would address this problem, the password generator and means of authenticating the one-time password must be configured to synchronize with each other, while preferable remaining out-of-band from the channel used to submit the one time password for authentication.

The inventors herein have recognized that the above issues may be addressed in part through systems and methods for initializing a mobile computing device as a one-time password generator, and further addressed through systems and methods for managing one-time password software on a mobile computing device. In one example, a method for a mobile computing device comprises downloading a one-time password initializer from an authentication server, the one-time password initializer configured to generate a device-specific signature for the mobile computing device; uploading a device-specific signature to the authentication server; and downloading a device-specific configuration and one-time password generator from the authentication server. In this way, both the mobile computing device and authentication server may independently generate equivalent one-time passwords based on unique information associated with the mobile computing device.

In another example, a method for a one-time password authentication server, comprising: responsive to a request to initialize a mobile computing device as a one-time password generator, downloading a one-time password initializer to the mobile computing device; receiving a device-specific signature for the mobile computing device from the one-time password initializer; generating a device-specific configuration and one-time password generator based on the device-specific signature; downloading the device-specific configuration and one-time password generator to the mobile computing device; and storing the device-specific configuration at the one-time password authentication server. In this way, the authentication server and mobile computing device may utilize equivalent algorithms to generate one-time passwords that are not time-dependent. Rather, the one-time passwords may be sequentially generated at both the server and mobile device based on the device-specific configuration.

In yet another example, a system for utilizing a mobile computing device as a one-time password generator, comprising: an authentication server configured to download a one-time password initializer to the mobile computing device, the one-time password initializer configured to: extract unique information from the mobile computing device; generate a device-specific signature based on the extracted unique information; and upload the device-specific signature to the authentication server. In this way, the mobile computing device may be utilized to generate a one-time password out of band from both the authentication server and any third-party servers requesting the one-time password for authentication.

### BRIEF FIGURE DESCRIPTIONS

FIG. 1 shows a schematic diagram of a system for one-time password authentication.

FIG. 2 schematically shows a system for initializing a mobile computing device as a one-time password generator.

FIG. 3 depicts a high-level flow chart for a method for the use and management of one-time password generating software on a mobile computing device.

FIG. 4 depicts a high-level flow chart for a method for initializing a mobile computing device as a one-time password generator.

FIG. 5 depicts a high-level flow chart for a method for generating a one-time password on a mobile computing device.

FIG. 6 depicts a high-level flow chart for a method for verifying a one-time password on an authentication server.

FIG. 7 depicts a high-level flow chart for a method for decoupling a mobile computing device from an authentication server.

### DETAILED SPECIFICATION

The present disclosure relates to systems and methods for one-time password generation and authentication. Specifically, a goal of the present disclosure is to increase user authentication security through the use of one-time password generation software installed on a mobile computing device. The one-time password generation software may be configured in such a way as to only be viable on the mobile computing device on which the software is stored. Equivalent software may be stored on an authentication server. In this way, a one-time password may be generated on a mobile computing device and verified on the authentication server in a manner that is out-of-band from transactions involving a 3^{rd} party service accessed by a user via a secondary computing device.

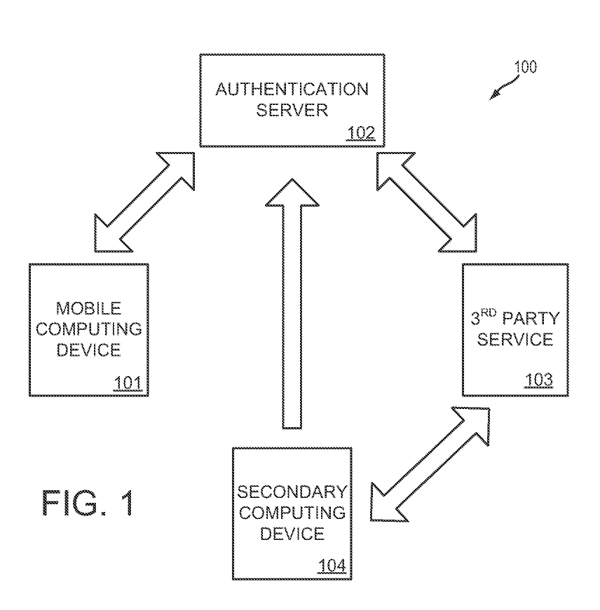

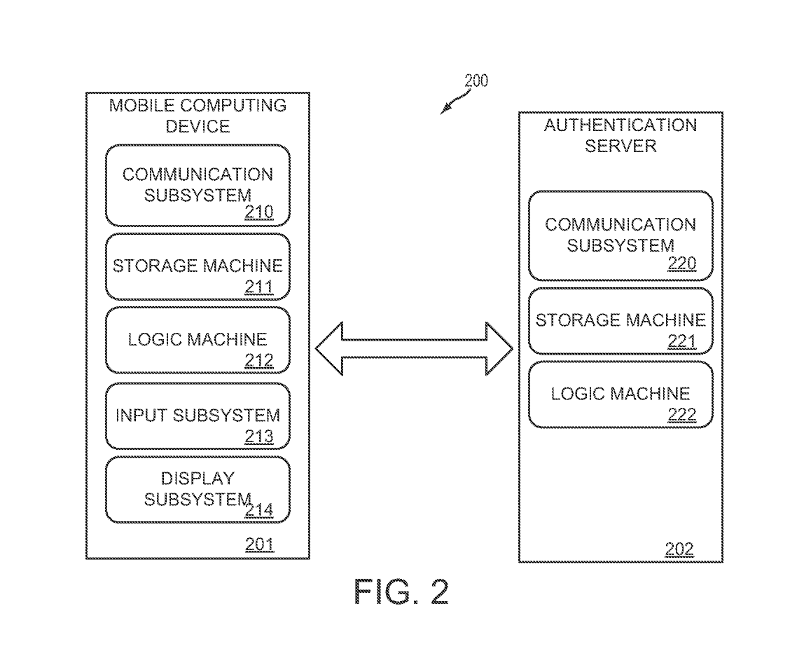

FIG. 1 shows a schematic diagram of a system 100 for one-time password authentication in accordance with the present disclosure. System 100 may include mobile computing device 101, authentication server 102, 3^{rd} party service 103 and secondary computing device 104. Mobile computing device 101 may be a smartphone, tablet computer, or other computing device. Authentication server 102 may be a web server, ftp server, cloud server, or other computing server that allows access to multiple computing devices simultaneously. Additional examples of mobile computing devices and authentication servers are described herein and with regard to FIG. 2. 3^{rd} party service 103 may be a website, server, computing exchange or other service requiring user authentication for access. Secondary computing device 104 may be a desktop computer, laptop computer, mobile computing device or other such computing device capable of accessing 3^{rd} party service 103.

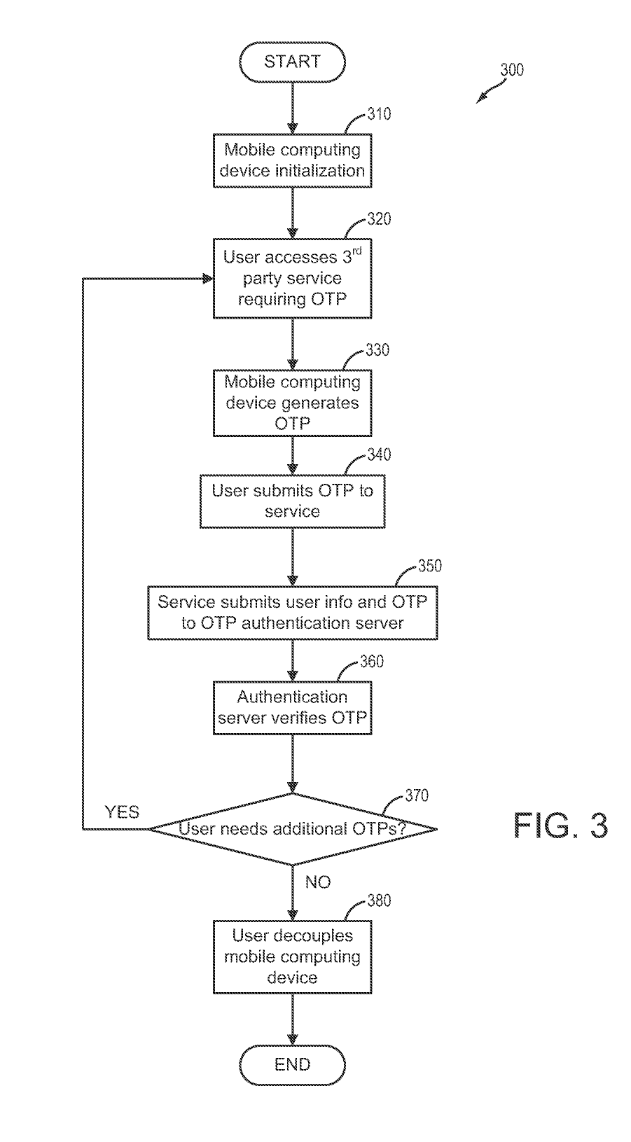

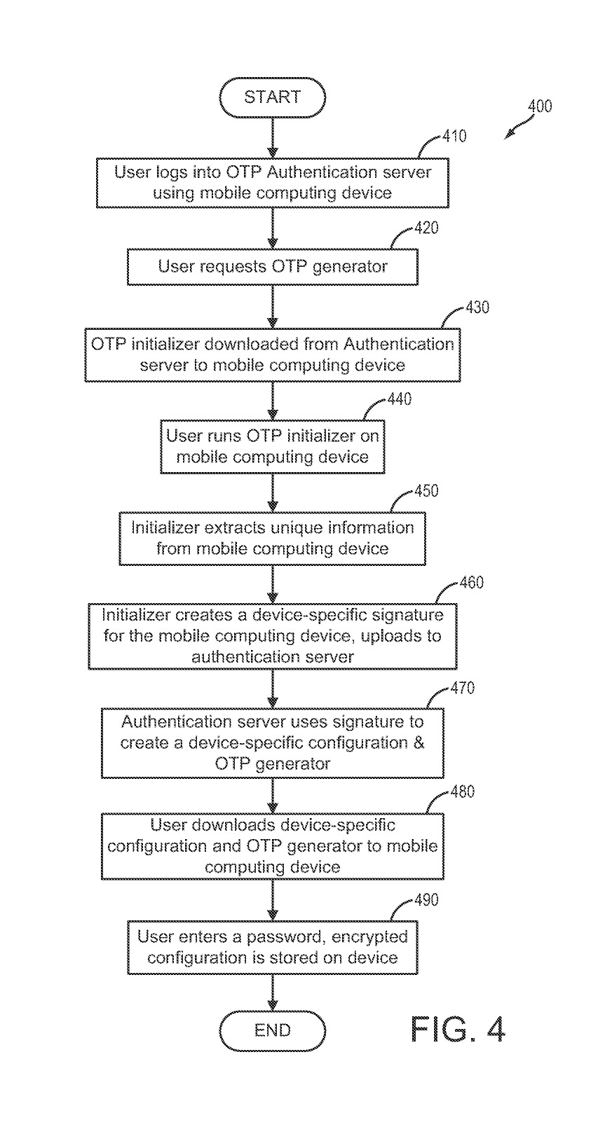

In one example, system 100 may be used to authenticate a user through one-time password authentication. In this embodiment, a user may access authentication server 102 with mobile computing device 101. Authentication server 102 may then extract unique information regarding mobile computing device 101 and install one-time password generating software on mobile computing device 101. This process is discussed in detail further herein and with regards to FIGS. 3 and 4. A user then may access 3^{rd} party service 103 with secondary computing device 104. 3^{rd} party service 103 may request a one-time password from the user in addition to a login ID and static password. The user may then use the one-time password generating software installed on mobile computing device 101 to generate a one-time password, and further submit the one-time password to 3^{rd} party service 103 via secondary computing device 104. In some embodiments, the user may be able to request access to 3^{rd} party service 103 via the same mobile computing device 101 that is used to generate the one-time password. 3^{rd} party service 103 may then submit the user credentials and one-time password to authentication server 102. Authentication server 102 may retrieve the unique information extracted from mobile computing device 101 and generate a one-time password. If the one-time password generated at server 102 matches the one-time password submitted by 3^{rd} party service 103, the server may return a message of verification to 3^{rd} party service 103. The user may then be granted access to 3^{rd} party service 103 via secondary computing device 104. The user may manage account information on authentication server 102 by accessing the server with secondary computing device 104. For example, the user may remove authorization for the one-time password generating software installed on mobile computing device 101.

FIG. 2 shows a schematic diagram of a system 200 for managing one-time password generation software on a mobile computing device. System 200 may include mobile computing device 201 and authentication server 202. Mobile computing device 201 and authentication server 202 may be configured to communicate in a manner that can allow enactment of one or more of the methods and processes described further herein and with regards to FIGS. 3-7. As shown for system 100 in FIG. 1, system 200 may also include a secondary computing device and 3^{rd} party service (not shown).

Mobile computing device 201 and authentication server 202 may be deployed in a system for one-time password authentication, such as the system described herein and with regards to FIG. 1. Mobile computing device 201 is shown in simplified form. It will be understood that virtually any computer architecture may be used without departing from the scope of this disclosure. In different embodiments, mobile computing device 201 may take the form of a smart phone, a personal digital assistant (PDA), a laptop computer, a mobile gaming device, a tablet computer, a wearable computing device, or other computing device that a user may use from multiple access points. Mobile computing device 201 includes a communication subsystem 210, a storage machine 211, a logic machine 212, an input subsystem 213 and a display subsystem 214, and/or other components not shown in FIG. 2.

Communication subsystem 210 may be configured to communicatively couple mobile computing device 201 with one or more other computing devices, such as authentication server 202. Communication subsystem 210 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow mobile computing device 201 to send and/or receive messages to and/or from other devices via a network such as the Internet.

Storage machine 211 includes one or more physical, non-transitory, devices configured to hold data and/or instructions executable by the logic machine to implement the methods and processes described herein. When such methods and processes are implemented, the state of storage machine 211 may be transformed—e.g., to hold different data.

Storage machine 211 may include removable media and/or built-in devices. Storage machine 211 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage machine 211 may include volatile, nonvolatile, dynamic, static, read/write, read-only, random-access, sequential-access, location-addressable, file-addressable, and/or content-addressable devices.

It will be appreciated that storage machine 211 includes one or more physical, non-transitory devices. However, in some embodiments, aspects of the instructions described herein may be propagated in a transitory fashion by a pure signal (e.g., an electromagnetic signal, an optical signal, etc.) that is not held by a physical device for a finite duration. Furthermore, data and/or other forms of information pertaining to the present disclosure may be propagated by a pure signal.

Logic machine 212 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic machine may include one or more processors configured to execute software instructions. Additionally or alternatively, the logic machine may include one or more hardware or firmware logic machines configured to execute hardware or firmware instructions. The processors of the logic machine may be single-core or multi-core, and the programs executed thereon may be configured for sequential, parallel or distributed processing. The logic machine may optionally include individual components that are distributed among two or more devices, which can be remotely located and/or configured for coordinated processing. Aspects of the logic machine may be virtualized and executed by remotely accessible, networked computing devices configured in a cloud-computing configuration.

In some embodiments, aspects of logic machine 212 and of storage machine 211 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

Input subsystem 213 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Display subsystem 214 may be used to present a visual representation of data held by storage machine 211. This visual representation may take the form of a graphical user interface (GUI). As the herein described methods and processes change the data held by the storage machine, and thus transform the state of the storage machine, the state of display subsystem 214 may likewise be transformed to visually represent changes in the underlying data. Display subsystem 214 may include one or more display devices utilizing virtually any type of technology. Such display devices may be combined with logic machine 212 and/or storage machine 211 in a shared enclosure, or such display devices may be peripheral display devices.

Authentication server 202 is shown in simplified form. Authentication server 202 may be employed in the form of a computing system or computing server. Authentication server 202 may be a physical computing system or server or may be a cloud-based computing system or server tethered to a physical computing system or server. It will be understood that virtually any computer architecture may be used without departing from the scope of this disclosure. Authentication server 202 includes a communication subsystem 220, a storage machine 221, a logic machine 222, and/or other components not shown in FIG. 2.

Communication subsystem 220 may be configured to communicatively couple authentication server 202 with one or more other computing devices, such as mobile computing device 201. Communication subsystem 220 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow authentication server 202 to send and/or receive messages to and/or from other devices via a network such as the Internet.

Storage machine 221 includes one or more physical, non-transitory, devices configured to hold data and/or instructions executable by the logic subsystem to implement the methods and processes described herein. When such methods and processes are implemented, the state of storage machine 221 may be transformed—e.g., to hold different data.

Storage machine 221 may include removable media and/or built-in devices. Storage machine 221 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage machine 221 may include volatile, nonvolatile, dynamic, static, read/write, read-only, random-access, sequential-access, location-addressable, file-addressable, and/or content-addressable devices.

It will be appreciated that storage machine 221 includes one or more physical, non-transitory devices. However, in some embodiments, aspects of the instructions described herein may be propagated in a transitory fashion by a pure signal (e.g., an electromagnetic signal, an optical signal, etc.) that is not held by a physical device for a finite duration. Furthermore, data and/or other forms of information pertaining to the present disclosure may be propagated by a pure signal.

Logic machine 222 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic machine may include one or more processors configured to execute software instructions. Additionally or alternatively, the logic machine may include one or more hardware or firmware logic machines configured to execute hardware or firmware instructions. The processors of the logic machine may be single-core or multi-core, and the programs executed thereon may be configured for sequential, parallel or distributed processing. The logic machine may optionally include individual components that are distributed among two or more devices, which can be remotely located and/or configured for coordinated processing. Aspects of the logic machine may be virtualized and executed by remotely accessible, networked computing devices configured in a cloud-computing configuration.

In some embodiments, aspects of logic machine 222 and of storage machine 221 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 3 depicts a flow chart for a high level method 300 for the use and management of one-time password generating software on a mobile computing device. Method 300 may begin at 310 with the initialization of a mobile computing device. A more detailed method for the initialization of a mobile computing device is described herein and with regard to FIG. 4. Briefly, the initialization of a mobile computing device may include the extraction of unique information pertaining to the mobile computing device and the user of the mobile computing device. The unique information may be uploaded to an authentication server. The authentication server may process the unique information and store the unique information in a secure storage machine. The unique information may be used to generate OTP generation software and configuration files that may then be downloaded to the mobile computing device. Equivalent software and configuration files may be stored on the authentication server. In this way, the same (or equivalent) OTP generation algorithm may be run on both the mobile computing device as well as the authentication server.

Method 300 may continue at 320 with a user accessing a 3^{rd} party service requiring an OTP. In some examples, this may involve a user accessing a 3^{rd} party service with a secondary computing device, such as a desktop or laptop computer, that is a different computing device than the mobile computing device which was initialized at 310. In some examples, the user may access a 3^{rd} party service with the same mobile computing device initialized for OTP generation. The accessing of a 3^{rd} party service may require the user to enter a static username and password. The 3^{rd} party service may be a web server or file server or other entity where 2-factor user authentication is required.

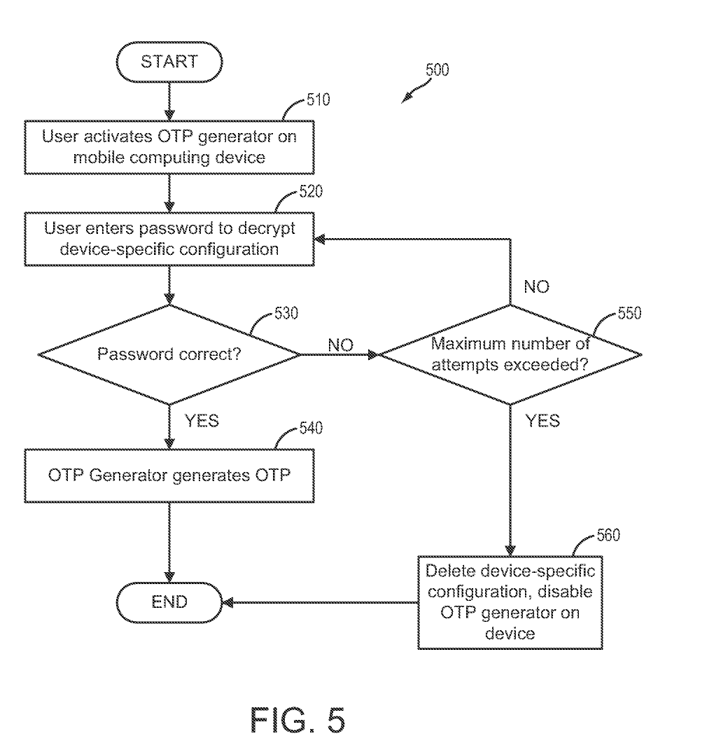

At 330, method 300 may include generating an OTP on the mobile computing device. A more detailed method for the generation of an OTP on a mobile computing device is described herein and with regard to FIG. 5. In some examples, the user may be required to enter a static encryption password on the mobile computing device to unlock or decrypt the device-specific configuration and/or OTP generation software. The OTP generator may generate an OTP that is generated once and only once; each OTP generated may thus be unique.

At 340, method 300 may include the user submitting the OTP to the 3^{rd} party service. At 350, method 300 may include the 3^{rd} party server submitting user information and the submitted OTP to the authentication server.

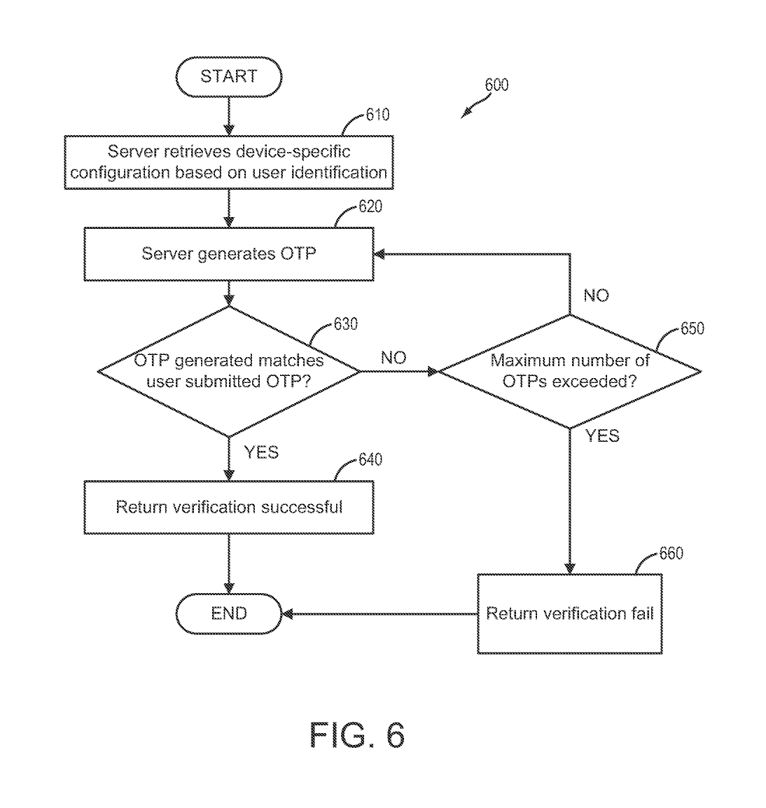

At 360, method 300 may include verifying the OTP on the authentication server. A more detailed method for the verification of an OTP is described herein and with regard to FIG. 6. The authentication server may retrieve the unique information about the user and the mobile computing device that was previously initialized. The authentication server may then generate an OTP based on the unique user and mobile computing device information stored previously. The authentication server may then compare the OTP generated on the server to the OTP generated on the mobile computing device. If the OTPs match, the server may return a notice of verification. If the OTPs do not match, the authentication server may generate additional OTPs in an effort to determine if the OTP submitted by the user is incorrect, or if the server and mobile computing device are out of sync.

At 370, method 300 may include determining if the user needs to generate additional OTPs, or may in the future need to generate additional OTPs with the same mobile computing device. This process may include user input confirming or denying the desire for continued use of the OTP generation software. If the user needs or anticipates needing additional OTPs, method 300 may return to 320 upon the user accessing a 3rd party service requiring an OTP. This may be the same 3^{rd} party service used previously, or may be a different 3^{rd} party service. If the user does not need to generate additional OTPs, method 300 may proceed to 380.

At 380, method 300 may include the user decoupling the mobile computing device from the authentication server. This may include removing the user and mobile computing device unique information from the authentication server. This may further include removing the device-specific configuration and OTP generation software from the mobile computing device. The decoupling process may be initiated by the user or may be initiated automatically, for example, if multiple incorrect logins suggest the user login or mobile computing device has been compromised. Method 300 may then end.

FIG. 4 depicts a flow chart for a high level method 400 for initializing a mobile computing device as a one-time password generator. Method 400 may be run independently, or may be run as a subroutine of method 300, or other similar methods for managing one-time password generating software on a mobile computing device. Method 400 may be used as part of a process for associating a user with a mobile computing device

Method 400 may begin at 410, wherein a user logs into an OTP authentication server with a mobile computing device. The mobile computing device may access the OTP authentication server through an http server, an ftp server, through a specific application installed on the mobile computing device, or other appropriate means of accessing a server. Accessing the authentication server may require the user to establish an account with the server, which may require the user to establish a username and/or password, and may require the user to input other unique identifying information. The user may initially log in to the authentication server in response to a 3^{rd} party service requesting OTP authentication, or in anticipation of using a 3^{rd} party service requiring OTP authentication. The user may disclose one or more 3^{rd} party services to the authentication server in anticipation of using the OTP generation software for authenticating exchanges between the user and the 3^{rd} party service.

At 420, method 400 may include the user requesting an OTP generator. The request may be made through a command, a form, message, or other suitable means of communicating with the authentication server as configured. In response to the request for an OTP generator, the authentication server may access or prepare an OTP initializer for the mobile computing device.

At 430, method 400 may include downloading the OTP initializer from the authentication server to the mobile computing device. The OTP initializer may be a stand-alone program or application to be run on the mobile computing device, or may be a plug-in or other add-on that may be run in or by a program or application already stored on the mobile computing device. The initializer may be specific for the operating system of the mobile computing device used to access the authentication server. The initializer may be downloaded in a compressed format, such as a zip or rar file which may then need to be unpackaged prior to installation on the mobile computing device. Following downloading and appropriate unpackaging, the initializer may then be installed on the mobile computing device.

At 440, method 400 may include the user running the OTP initializer on the mobile computing device. In some examples, the user may initiate or launch the OTP initializer following installation. In other examples, the installation process may trigger the initiation or launch of the OTP initializer immediately following installation. In some examples, the OTP initializer may be run in a secure kernel of the mobile computing device.

At 450, method 400 may include the initializer extracting information from the mobile computing device. The information extracted by the initializer may be identifying information unique to the mobile computing device. This information may include serial numbers such as an International Mobile Station Equipment Identity (IMEI) code, Subscriber Identity Module (SIM) card identifiers such as a SIM serial number (SSN), an Electronic Product Code (EPC), a processor number, a Message Authentication Code (MAC), or other unique codes associated with the mobile computing device or its components. Other authentication factors or codes may be extracted from data permanently stored in the storage machine of the mobile computing device. The initializer may install or otherwise impart additional unique codes or identifiers that may also be extracted.

At 460, method 400 may include the initializer creating a device-specific signature for the mobile computing device, and uploading the device-specific signature to the authentication server. The device-specific signature may be a function of the unique identifying information extracted by the initializer at 450, and may further be a function of unique user identifiers. The device-specific signature may then be stored in a secure portion of the authentication server.

At 470, method 400 may include the authentication server utilizing the device-specific signature to create a device-specific configuration unique to the user and mobile computing device. The authentication server may also generate an OTP generator specific for the mobile computing device. In some examples, the OTP generator may be a generic application that can be run on a plurality of devices with the same operating system, but is configured to run only when paired with a device-specific configuration unique for a specific mobile computing device. The device-specific configuration and/or OTP generator may be stored in a secure portion of the authentication server.

At 480, method 400 may include the user downloading the device-specific configuration and OTP generator to the mobile computing device. In this example, the device-specific configuration and OTP generator may be stored on both the mobile computing device and the authentication server. In this way, the OTP generator may be run on both the mobile computing device and authentication server without direct communication between the device and the server. In some examples, a device-specific configuration may not be stored on the authentication server as an additional security measure. In these examples, a device-specific configuration may be generated upon retrieval of the device-specific signature, and deleted following generation and verification of an OTP on the authentication server.

At 490, method 400 may include the user encrypting the device-specific configuration with a password and storing the encrypted device-specific configuration on the device. The password may be restricted to passwords that are unique from other passwords associated with the user account on the Authentication server. The device-specific configuration may also be encrypted by a password or passwords used by the user to authenticate use of the mobile computing device, such as a login or unlocking password. Method 400 may then end.

FIG. 5 depicts a flow chart for a high-level method 500 for generating a one-time password on a mobile device in accordance with the current disclosure. Method 500 may be run independently, or may be run as a subroutine of method 300, or other similar methods for managing one-time password generating software on a mobile computing device. Method 500 may be used as part of a process for authenticating a user accessing a 3^{rd} party service requiring a one-time password.

Method 500 may begin at 510 with a user activating an OTP generator installed on a mobile computing device. Activating an OTP generator may include launching the OTP generator software, for example. The user may choose to activate the OTP generator in response to a request for a one-time password from a 3^{rd} party service.

At 520, method 500 may include the user entering a password to decrypt the device-specific configuration. As described herein with regards to FIG. 4, the user may encrypt the device-specific configuration with a password upon downloading the device-specific configuration and OTP generation software from the authentication server. In some examples, no password may be required in addition to the user login or unlocking password.

At 530, method 500 may include the OTP generation software determining whether the password is correct. This may include matching the entered password to the stored password, or completing an algorithm with the entered password and comparing the result to a predetermined answer. If the password is correct, method 500 may proceed to 540. If the password is incorrect, method 500 may proceed to 550.

At 550, method 500 may include the OTP generation software determining whether a maximum number of attempts at entering a correct password has been exceeded. The OTP generating software may allow a predetermined number of attempts at entering a correct password, for example 3 attempts. The number of attempts may be counted from the time the OTP generating software is activated, or may be counted over a period of time, for example the number of attempts within 5 minutes of the first attempt. A variable may be assigned to represent the number of attempts. The variable may be set equal to zero upon activation of the OTP generating software, or upon the entering of a correct password. Each incorrect password entered may result in a value of one being added to the variable.

If the maximum number of attempts has been exceeded, method 500 may proceed to 560. At 560, method 500 may include the OTP generation software deleting the device-specific configuration and disabling the software installed on the mobile computing device. In this way, if the mobile computing device is lost or stolen, an unauthorized user would not be able to access the OTP generation software without a correct password. The user may then have to re-apply for a new device-specific configuration and OTP generator, as described herein and with regards to FIG. 4.

If the maximum number of attempts has not been exceeded, method 500 may return to 520. The OTP generating software may prompt the user to enter a password. The OTP generating software may indicate to the user the number of attempts remaining before the maximum number of attempts will be reached.

If and when the user enters the correct password, the OTP generating software will generate a one-time password using the device-specific configuration associated with the mobile computing device. The one-time password may be a unique code, and may not be generated in a manner dependent on the time of generation.

FIG. 6 depicts a flow chart for a high-level method 600 for verifying a one-time password generated on a mobile device in accordance with the current disclosure. Method 600 may be run independently, or may be run as a subroutine of method 300, or other similar methods for managing one-time password generating software on a mobile computing device. Method 600 may be used as part of a process for authenticating a user accessing a 3^{rd} party service requiring a one-time password. Method 600 may follow method 500, or other similar methods for OTP generation which result in a user identification and mobile computing device generated OTP being submitted to an authentication server by a 3^{rd} party service.

Method 600 may begin at 610 with an authentication server retrieving specific device information based on user identification. Retrieval of specific device information may be triggered by a 3^{rd} party service submitting a user ID, password and OTP generated on a mobile device to the authentication server for authentication. The specific device information retrieved may include the device-specific signature discussed herein and with regards to FIG. 4. In some embodiments, the specific device information may include a device-specific configuration and/or a device-specific OTP generator. The device-specific configuration and/or device-specific OTP generator may be stored on the authentication server and may be equivalent to the device-specific configuration and/or device-specific OTP generator stored on the mobile computing device.

At 620, method 600 may include generating an OTP on the authentication server. By utilizing the user specific and device specific information retrieved at 610, the authentication server may be able to run the same OTP generating algorithm that was run on the mobile computing device.

At 630, method 600 may include the OTP generation software determining whether the OTP generated on the authentication server matches the OTP submitted by the 3^{rd} party service. This may include matching the generated OTP to the submitted OTP, or completing an algorithm with the generated OTP and the submitted OTP and comparing the results. If the OTPs match, method 600 may proceed to 640. If the OTPs do not match, method 600 may proceed to 650.

At 650, method 500 may include the OTP generation software determining whether a maximum number of attempts at generating an OTP that matches the OTP submitted to the authentication server by the 3^{rd} party service has been exceeded. The OTP generation software may be configured such that each time the software is run, a new OTP is created without being dependent on the time the software was run. The OTP generation algorithm may be dependent on the number of times the software is run or the number of OTPs that have been generated since the initialization of the mobile computing device. A variable may be stored at the authentication server as well as at the mobile computing device indicative of the number of OTPs generated. Each successive OTP generated may result in a value of one being added to the variable. Alternatively, the variable may be a complex function that factors the previously generated OTP into the function. The variable may be incorporated into the OTP generation algorithm. When the mobile computing device is initialized as an OTP generator, the mobile computing device and authentication server may both reflect that zero OTPs have been generated with the current configuration. If each OTP generated by the mobile device is submitted to the authentication server for verification, the mobile computing device and authentication server should remain in sync; in other words, the device and server should reflect the same number of OTPs have been generated. However, if an OTP is generated on the mobile computing device and not submitted to the authentication server, the device and server may become out-of-sync, or reflect that a different number of OTPs have been generated. This may occur due to a user generating an OTP accidentally, for example, or if a communication link is interrupted in the submission of an OTP to the 3^{rd} party service, or from the 3^{rd} party service to the authentication server. The user may then generate a new OTP without the authentication server recognizing that the number of OTPs generated by the mobile computing device has increased.

The OTP generating software may allow a predetermined number of attempts at generating a matching OTP, for example 3 attempts. The number of attempts may be counted from the time the OTP authentication server retrieves specific device information. A variable may be assigned to represent the number of attempts. The variable may be set equal to zero upon retrieval of specific device information, or upon the generation of an OTP that matches a submitted OTP. Each incorrect OTP generated may result in a value of one being added to the variable.

If the maximum number of attempts has been exceeded, method 600 may proceed to 660. At 660, method 600 may include the OTP generation software returning a verification fail message to the 3^{rd} party service. The message may be further communicated to the mobile computing device and/or the secondary computing device used to access the 3^{rd} party service. In some examples, method 600 may include the OTP generation software deleting the device-specific configuration and disabling the software installed on the mobile computing device. Method 600 may then end.

If the maximum number of OTPs generated has not been exceeded, method 600 may return to 620. The authentication server may then proceed to generate the next OTP in sequence, taking into account a change in the variable reflecting the number of OTPs that have been generated. In this way, the server may effectively “look forward” to determine if the submitted OTP does not match the generated OTP due to the mobile computing device becoming out of sync with the authentication server. As discussed herein, this may occur due to the user generating one or more OTPs on the mobile computing device without submitting the one or more OTPs to the authentication server for authentication.

If and when the authentication server generates an OTP that matches the OTP submitted by the 3^{rd} party service, method 600 may proceed to 640 and return a verification successful message to the 3^{rd} party service. The user may then be allowed to access the 3^{rd} party service through the secondary computing device. If the authentication server generated multiple OTPs before matching an OTP to the submitted OTP, the authentication server may communicate with the mobile computing device to sync the OTP generator on the mobile computing device to the OTP generator on the authentication server. Method 600 may then end.

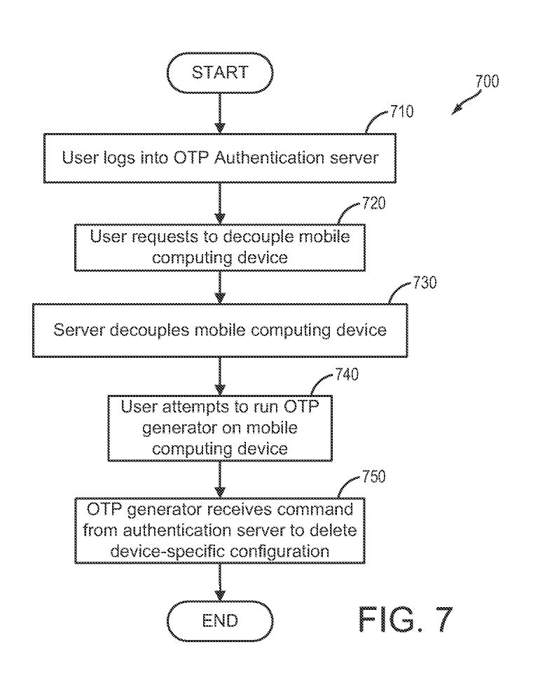

FIG. 7 depicts a flow chart for a high-level method 700 for decoupling a mobile computing device from an authentication server. Method 700 may be run independently, or may be run as a subroutine of method 300, or other similar methods for managing one-time password generating software on a mobile computing device.

Method 700 may begin at 710 with a user logging into an OTP authentication server using a secondary computing device. The secondary computing device may access the OTP authentication server through an http server, an ftp server, through a specific application installed on the mobile computing device, or other appropriate means of accessing a server. Accessing the authentication server may require the user input a username and/or password, and may require the user to input other unique identifying information.

At 720, the user may request to decouple the mobile computing device from the authentication server. The request may be made through a command or through the selection of an option presented on the authentication server. Continuing at 730, the server may then decouple the mobile computing device. Decoupling the mobile computing device may include deleting an essential component of the OTP generation software, such as a permission code.

Continuing at 740, method 700 may include the user launching or attempting to run the OTP generator on the mobile computing device. At 750, the attempt to run the decoupled OTP generation software may result in the OTP generator receiving a command from the authentication server to delete the device-specific configuration stored on the mobile computing device. Method 700 may then end. In this way, if a user loses the initialized mobile computing device, the user may request to decouple the mobile computing device to prevent unauthorized use of the OTP generating software.

It will be understood that the systems and methods described herein are exemplary in nature, and that these specific embodiments or examples are not to be considered in a limiting sense, because numerous variations are contemplated. Accordingly, the present disclosure includes all novel and non-obvious combinations and sub-combinations of the various systems and methods disclosed herein, as well as any and all equivalents thereof. Further, it will be appreciated that in some embodiments the methods and systems described herein may include additional or alternative processes, while in some embodiments, the methods described herein may include some processes that may be reordered, performed in parallel or omitted without departing from the scope of the present disclosure. Further, it will be appreciated that the methods described herein may be performed using any suitable software and hardware including the specific examples described herein.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples as understood by those of ordinary skill in the art. Such other examples are intended to be within the scope of the claims.

1. A method for a mobile computing device, comprising:
downloading a one-time password initializer from an authentication server, the one-time password initializer configured to generate a device-specific signature for the mobile computing device;
uploading the device-specific signature to the authentication server; and
downloading a device-specific configuration and one-time password generator from the authentication server.

2. The method of claim 1, where the one-time password initializer is further configured to:
extract unique information from the mobile computing device; and
generate a device-specific signature for the mobile computing device based on the extracted unique information.

3. The method of claim 1, further comprising:
encrypting the device-specific configuration with an encryption password.

4. The method of claim 3, further comprising:
responsive to a request from a user for a one-time password, prompting the user to enter the encryption password; and
responsive to receiving the encryption password, generating a one-time password.

5. The method of claim 4, further comprising:
responsive to receiving an incorrect encryption password, deleting the device-specific configuration; and
disabling the one-time password generator on the mobile computing device.

6. The method of claim 5, where deleting the device-specific configuration responsive to receiving an incorrect encryption password further comprises:
deleting the device-specific configuration following receiving a threshold number of incorrect encryption passwords.

7. The method of claim 1, where downloading a one-time password initializer from the authentication server further comprises:
responsive to a user request to initialize the mobile computing device as a one-time password generator, accessing the authentication server; and
requesting a one-time password generator from the authentication server.

8. A method for a one-time password authentication server, comprising:
responsive to a request to initialize a mobile computing device as a one-time password generator, downloading a one-time password initializer to the mobile computing device;
receiving a device-specific signature for the mobile computing device from the one-time password initializer;
generating a device-specific configuration and one-time password generator based on the device-specific signature;
downloading the device-specific configuration and one-time password generator to the mobile computing device; and
storing the device-specific configuration at the one-time password authentication server.

9. The method of claim 8, further comprising:
receiving a request for authentication, the request for authentication indicating a one-time password and an associated mobile computing device;
retrieving the device-specific configuration for the associated mobile computing device;
generating a one-time password at the one-time password authentication server based on the device-specific configuration;
comparing the one-time password generated at the one-time password authentication server to the one-time password indicated by the request for authentication; and
indicating authentication if the one-time password generated at the one-time password authentication server matches the one-time password indicated by the request for authentication.

10. The method of claim 9, further comprising:
responsive to the one-time password generated at the one-time password authentication server not matching the one-time password indicated by the request for authentication, generating a subsequent one-time password based on the device-specific configuration; and
indicating authentication if the subsequent one-time password generated at the one-time password authentication server matches the one-time password indicated by the request for authentication.

11. The method claim 10, further comprising:
responsive to the subsequent one-time password time password generated at the one-time password authentication server not matching the one-time password indicated by the request for authentication, indicating a failed verification if a number of subsequent one-time passwords generated is greater than a threshold.

12. The method of claim 8, further comprising:
decoupling the initialized mobile computing device responsive to a user request; and then
responsive to a user attempting to generate a one-time password on the decoupled mobile computing device, issuing a command to the one-time password generator to delete the device-specific configuration at the mobile computing device.

13. The method of claim 12, where decoupling the initialized mobile computing device further comprises:
deleting the device-specific configuration associated with the initialized mobile computing device from the one-time password authentication server.

14. The method of claim 8, further comprising:
storing the device-specific signature for the mobile computing device at the one-time password authentication server.

15. The method of claim 9, where receiving a request for authentication further comprises:
receiving a request for authentication from a third-party server.

16. A system for utilizing a mobile computing device as a one-time password generator, comprising:
an authentication server configured to download a one-time password initializer to the mobile computing device, the one-time password initializer configured to:
extract unique information from the mobile computing device;
generate a device-specific signature based on the extracted unique information; and
upload the device-specific signature to the authentication server.

17. The system of claim 16, where the authentication server is further configured to:
store the device-specific signature;
generate a device-specific configuration and one-time password generator based on the device-specific signature; and
download the device-specific configuration and one-time password generator to the mobile computing device.

18. The system of claim 17, where the one-time password generator is configured to:
generate a unique one-time password based on the device-specific signature responsive to a user request for a one-time password.

19. The system of claim 18, where the authentication server is further configured to:
receive a request for authentication from a third-party server, the request for authentication indicating a submitted one-time password and an associated mobile computing device.
retrieve the device-specific configuration for the associated mobile computing device;
generate a one-time password at the authentication server based on the device-specific configuration;
compare the one-time password generated at the authentication server to the one-time password indicated by the request for authentication; and
indicating authentication if the one-time password generated at the authentication server matches the one-time password indicated by the request for authentication.

20. The system of claim 19, where the authentication server and the one-time password generator stored on the mobile computing device are each configured to generate a plurality of one-time passwords based on the device-specific configuration, the plurality of one-time passwords generated in a same order at the authentication server and the mobile computing device.
